(19) United States
(12) Patent Application Publication
(10) Pub. No.: US 2005/0270637 A1
(43) Pub. Date: Dec. 8, 2005

(54) Display device

(75) Inventor: Nai-Yueh Liang, Taipei City (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 10/983,735

(22) Filed: Nov. 9, 2004

(30) Foreign Application Priority Data
Jun. 4, 2004 (TW) 093116250

(51) Int. Cl. G02B 21/36; G02B 23/00

(52) U.S. Cl. 359/363

(57) ABSTRACT

A display device includes a light source, an image-gaining processing module, a modulating module and an imager. In this case, the image-gaining processing module, which receives an image signal, generates a gain value, and generates an image-gaining signal according to the gain value and the image signal. The modulating module electrically connected with the light source and the image-gaining processing module, wherein the modulating module generates a control signal according to the gain value to control the brightness of the light from the light source to become a multiple of the original brightness of the light from the light source and the inverse of the gain value. The imager electrically connected with the image-gaining processing module, wherein the imager receives the image-gaining signal, and produces an image using the controlled light from the light source.

### BACKGROUND OF THE INVENTION

1. Field of Invention

The invention relates to a display device and, in particular, to a display device with a large dynamic range.

2. Related Art

With the arrival of a multimedia era, the use of display devices, such as a CRT display, a LCD display, a plasma display, an electroluminescent display and a projection display, has become popular more and more in every field.

The image projecting systems can be divided into different types, such as CRT projector, LCD projector and DLP projector. The LCD projector and the DLP projector have come into widespread use because they are suitable for high luminance and high display quality.

However, the dynamic range of the LCD projector and the PLD projector is not large. For instance, the actual dynamic range of a LCD projector is about 300-400:1, and the actual dynamic range of a DLP projector is about 500-600:1 (here, a device has a large dynamic range means that it is able to display an image with high contrast and many-levels of gradation). If the dynamic range of a display device is not large enough, a user cannot differentiate images if the brightness of the images is darker (such as night images).

To solve this problem, U.S. Pat. No. 6,683,657 disclosed a projection display system 3, in which an illumination-light amount modulating means is provided to adjust the light amount illuminated to an optical modulator. As shown in FIG. 1, the light illuminated from a light source 31 is reflected by a reflector 32 and becomes a parallel light beam. After passing an integrator 33, the parallel light beam enters a PS converter 34, and is converted from a non-polarized light beam to a linearly-polarized light beam.

The linearly-polarized light beam then enters the optical device 35 having a rotatable polarizing plate. Afterwards the light beam illuminates to the LCD panel 38 via a plurality of reflection layers 36 and prisms 37. The LCD panel 38 controls the light beam to form an image. The polarizing plate is driven by a motor (not shown in the drawing). Since the polarizing plate rotates continuously, the amount of light entering the LCD panel 38 changes accordingly. The amount of light entering the LCD panel 38 is determined according to the input image signal, and the rotation angle of the polarizing plate, which correspondents to the rotation angle of the motor, is calculated in view of the amount of light.

However, the image projecting system mentioned above has an additional illumination-light amount modulating means, which makes the system heavier and larger, and thus not suitable for a compact projection system. Moreover, the angle of the polarizing plate is adjusted mechanically via a motor, which limits the precision of angle adjustment.

### SUMMARY OF THE INVENTION

In view of the above-mentioned problems, the invention is to provide a display device with an increased dynamic range.

To achieve the above, in one embodiment of the invention, the display device includes a light source, an image-gaining processing module, a modulating module and an imager. The image-gaining processing module receives an image signal, generates a gain value, and generates an image-gaining signal according to the gain value and the image signal. The modulating module is electrically connected with the light source and the image-gaining processing module, and generates a control signal according to the gain value to control the brightness of the light from the light source to become a multiple of the original brightness of the light from the light source and the inverse of the gain value. The imager is electrically connected with the image-gaining processing module, receives the image-gaining signal, and produces an image using the controlled light from the light source.

In another embodiment of the invention, the display device includes a light source, an image gaining module, a modulating module, an image processing module and an imager. The image gaining module receives an image signal A and generates a gain value. The modulating module is electrically connected with the light source and the image gaining module, and generates a control signal according to the gain value to control the brightness of the light from the light source to become a multiple of the original brightness of the light from the light source and the inverse of the gain value. The image processing module is electrically connected with the image gaining module, and generates an image-gaining signal A′ according to the gain value and the image signal A. The imager is electrically connected with the image-gaining processing module, receives the image-gaining signal A′, and produces an image using the controlled light from the light source.

From the above, the display device according to the invention obtains a gain value using the input signal, multiplies the input signal by the gain value, and adjusts the brightness of the light to become the multiple of the inverse of the gain value to enhance the dynamic range of the display device. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram of a display device in the prior art.

FIG. 2 is a schematic diagram of a display device according to the first embodiment of the invention.

FIG. 3 is a schematic diagram showing an example of calculating the image signal A_{G} and the image signal A_{G}′ in the first embodiment.

FIG. 4 is another schematic diagram of a display device according to the first embodiment of the invention.

FIG. 5 is a schematic diagram showing a DLP projector according to the first embodiment.

FIG. 6 is a schematic diagram showing an LCD display according to the first embodiment.

FIG. 7 is a schematic diagram of a display device according to the second embodiment of the invention.

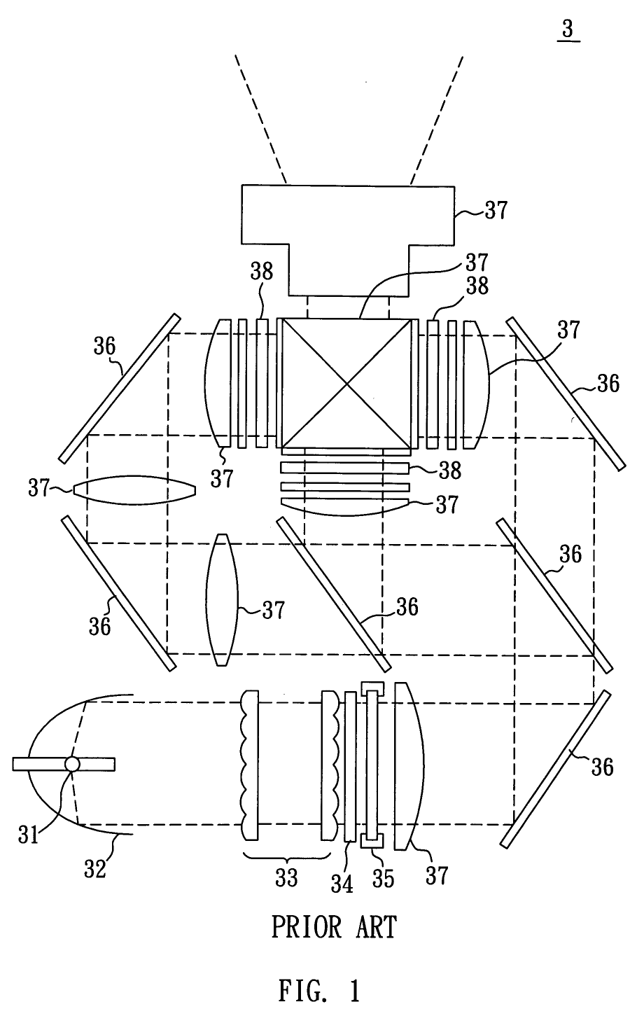

### DETAILED DESCRIPTION OF THE INVENTION

The display devices according to the preferred embodiments of the invention will be described hereinbelow with reference to relevant drawings.

### First Embodiment

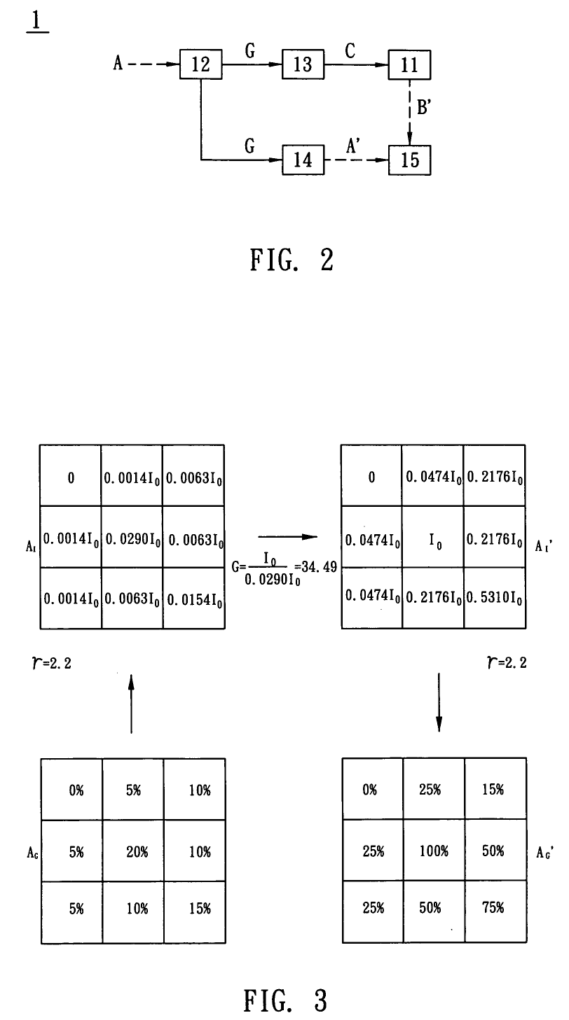

As shown in FIG. 2, the display device 1 according to the first embodiment of the invention includes a light source 11, an image gaining module 12, a modulating module 13, an image processing module 14 and an imager 15. The image gaining module 12 receives an image signal A and generates a gain value G. The modulating module 13 is electrically connected with the light source 11 and the image gaining module 12, and generates a control signal C to control the brightness B′ of the light source 11 according to the gain value G, wherein the brightness B′ comes out by multiplying the brightness B of the original light by the inverse of the gain value (1/G). The image processing module 14 is electrically connected with the image gaining module 12, and generates an image-gaining signal A′ according to the gain value G and the image signal A. The imager 15 is electrically connected with the image processing module 14, receives the image-gaining signal A′, and produces an image using the adjusted light from the light source.

In the present embodiment, the light source 11 emits light for image production. The light source 11 may be a digital-controlled or analog-controlled light source. For instance, the light source may be a light-emitting diode (LED), a light bulb, a laser (such as a semiconductor laser), an organic LED, an ultrahigh-press mercury lamp, a metal halide lamp, a xenon lamp or a halogen lamp.

The image gaining module 12 in the present embodiment generates the gain value G using the image signal A, which signal is provided by an image source (not shown in the drawing). For example, the image source may be a computer input terminal, an NTSC input terminal, an LVDS input terminal, a TMDS input terminal, or a D-32 terminal. The image source may be a digital image source or an analog image source. When the image source is an analog image source, the display device 1 may further include an AD converter to convert analog signals to digital signals.

In the present embodiment, the image gaining module 12 determines the maximum gray level of the image signal A, and divides the maximum gray level of the imager 15 by the maximum gray level of the image signal A to obtain the gain value G Alternatively, the image gaining module 12 may determine the maximum intensity of the image signal A, and divides the maximum intensity of the imager 15 by the maximum intensity of the image signal A to obtain the gain value G

Since the image signal A can be represented by either intensity or gray level, in the present embodiment, the image signal represented by intensity is called the image intensity signal A_{I}, and the image signal represented by gray level is called the image gray level signal A_{G}.

As shown in FIG. 3, the image gaining module 12 may convert the image gray level signal A_{G} into the image intensity signal A_{I} to determine the maximum intensity of the image intensity signal A_{I}, and then obtain the gain value G by dividing the maximum intensity of the imager 15 by the maximum intensity of the image intensity signal A_{I}.

The image gray level signal A_{G} can be converted into the image intensity signal A_{I} by the following formula:
A_{I}=I₀×(A_{G})^{T} (1)
wherein I₀ is the intensity value, A_{G} is the image gray level signal, A_{I} is the image intensity signal, and γ is an arbitrary number (for example, γ is 2.2 for a CRT display).

Alternatively, the image gaining module 12 may convert the image intensity signal A_{I} into the image gray level signal A_{G}, determine the maximum gray level of the image gray level signal A_{G}, and divide the maximum gray level of the imager 15 by the maximum gray level of the image gray level signal A_{G} to obtain the gain value G The image intensity signal A_{I} can be converted into the mage gray level signal A_{G} using the following formula:
A_{G}=(A_{I}/I₀)^{1/γ} (2)
wherein I₀ is the intensity value, A_{G} is the image gray level signal, A_{I} is the image intensity signal, and γ is an arbitrary number (for example, γ is 2.2 for a CRT display).

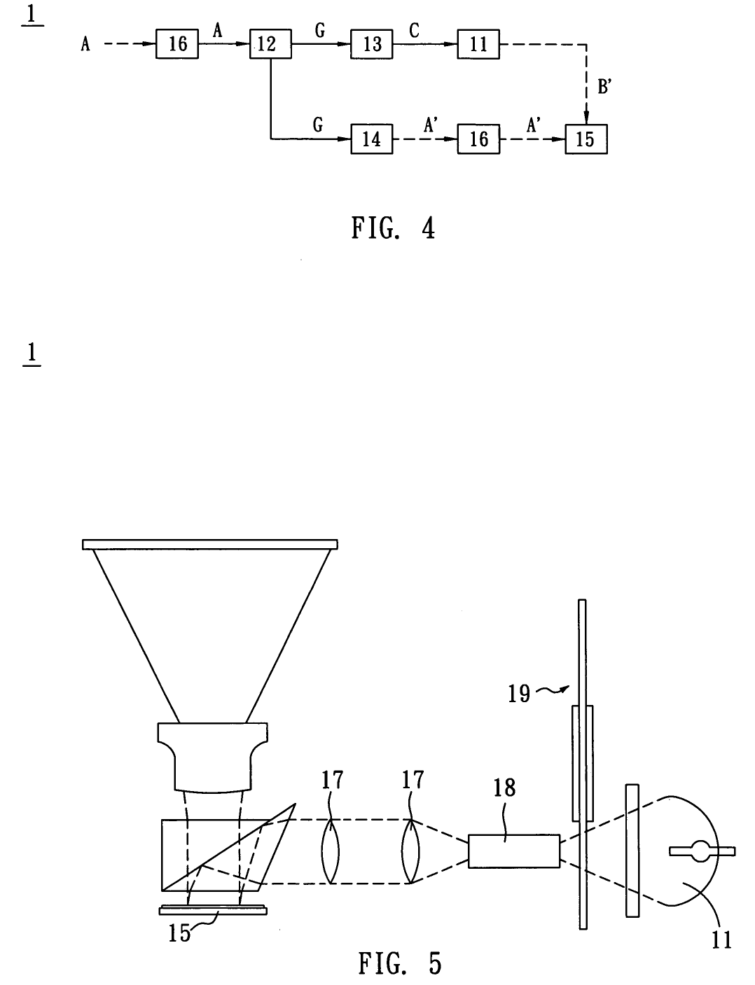

As shown in FIG. 4, the display device 1 according to the present embodiment may further include a gray level processing module 16. The gray level processing module 16 converts the image gray level signal A_{G} into the image intensity signal A_{I}, or converts the image intensity signal A_{I} into the image gray level signal A_{G}, using formula (1) or (2) mentioned above.

Furthermore, as shown in FIG. 2, the modulating module 13 is electrically connected with the light source 11 and the image gaining module 12, and generates a control signal C to control the brightness B′ of the light source 11 according to the gain value G, wherein the brightness B′ comes out by multiplying the brightness B of the original light by the inverse of the gain value (1/G). That is, B′=B/G. For example, if the brightness of the original light is B₀, the brightness of the adjusted light is B₀/G. Here, the modulating module 13 may be a digital modulating module or an analog modulating module.

Moreover, the modulating module 13 may also control the open/close time of the light source 11, so that the brightness B′ of the light emitted by the light source 11 becomes the multiple of the brightness B of the original light and the inverse of the gain value G.

As shown in FIG. 2, the image processing module 14 is electrically connected with the image gaining module 12, and generates an image-gaining signal A′ according to the gain value G and the image signal A. In other words, the image-gaining signal A′ equals to the multiple of the gain value G and the image signal A, that is, A′=A×G.

When the image signal A is the image gray level signal A_{G}, it becomes an image-gaining signal represented by gray level, that is, an image gray level-gaining signal A_{G}′, after multiplied by the gain value G. On the other hand, when the image signal A is the image intensity signal A_{I}, it becomes an image-gaining signal represented by intensity, that is, an image intensity-gaining signal A_{I}′, after multiplied by the gain value G

The way of obtaining the gain value and the image-gaining signal A′ will be described with reference to FIG. 3. First, the image gray level signal A_{G} is converted to the image intensity signal A_{I}. Then, the image gaining module 12 determines the maximum intensity of the image intensity signal A_{I}, that is, 0.0290 I₀. Then, the maximum intensity of the imager 15 (I₀) is divided by the maximum intensity of the image intensity signal A_{I} (0.0290I₀) to obtain the gain value G (=34.49). Then, the image processing module 14 generates the image intensity-gaining signal A_{I}′ according to the gain value G (=34.49) and the image intensity signal A_{I}. Lastly, the image intensity-gaining signal A_{I}′ is converted to the image gray level-gaining signal A_{G}′.

Please refer to FIG. 3 again, in the present embodiment, the image gaining module 12 converts the image intensity-gaining signal A_{I}′ to the image gray level-gaining signal A_{G}′ using the following formula:
A_{G}′=(A_{I}/I₀)^{1/γ} (3)
wherein I₀ is the intensity value, A_{G}′ is the image gray level-gaining signal, A_{I}′ is the image intensity-gaining signal and γ is an arbitrary number (for example, γ is 2.2 for a CRT display).

When the image processing module 14 generates the image gray level-gaining signal A_{G}′, the image gaining module 12 may convert the image gray level-gaining signal A_{G}′ to the image intensity-gaining signal A_{I}′ using the following formula:
A_{I}′=I₀*(A_{G}′)^{γ} (4)
wherein I₀ is the intensity value, A_{G}′ is the image gray level-gaining signal, A_{I}′ is the image intensity-gaining signal and γ is an arbitrary number (for example, γ is 2.2 for a CRT display).

Moreover, the gray level processing module 16 may convert the image intensity-gaining signal A_{I}′ to the image gray level-gaining signal A_{G}′ using formula (3) mentioned above, or convert the image gray level-gaining signal A_{G}′ to the image intensity-gaining signal A_{I}′ using the formula (4) mentioned above.

Please refer to FIG. 2, the imager 15 is electrically connected with the image processing module 14. The imager 15 receives the image-gaining signal A′ (either A_{G}′ or A_{I}′), and produces an image using the adjusted light from the light source 11 (the brightness B′ of the adjusted light equals to the multiple of the original brightness B and the inverse of the gain value). This image substantially equals to the image signal

In the present embodiment, the display device 1 includes, but not limited to, a DLP projector, a transparent type projector, a reflection type projector, or an LCD display.

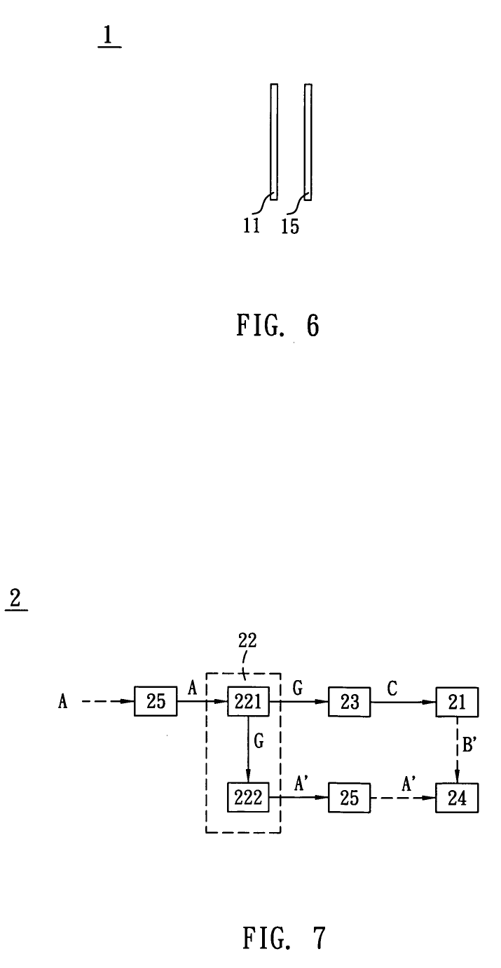

In the present embodiment, the imager 15 includes a display screen when the display device 1 is a projection display device. As shown in FIG. 5, when the display device 1 is a DLP projector, the imager 15 further includes a DMD (digital micro-mirror device). Furthermore, when the display device 1 is a transparent type LCD projector, the imager 15 further includes an LCD light valve. When the display device 1 is a reflection type LCD projector, the imager 15 further includes an LCD reflection panel. As shown in FIG. 6, certainly the display device 1 may be an LCD display, wherein the imager 15 is an LCD panel.

The display device 1 according to the present embodiment further includes a focus unit 17, as shown in FIG. 5. The focus unit 17 focuses the light emitted by the light source 11. Here, the focus unit 17 is provided on the light path. For example, the focus unit 17 can be provided between the light source 11 and the imager 15.

The display device 1 according to the present embodiment further includes an optical guide 18, as shown in FIG. 5. The optical guide 18 is provided on the light path to make uniform the light emitted from the light source 11. The optical guide also has the function of light guiding or changing the direction of light. For example, the optical guide 18 may be a light tunnel. Please refer to FIG. 5 again, the optical guide 18 is provided at the two sides of the color wheel 19.

### Second Embodiment

As shown in FIG. 7, the display device 2 according to the second embodiment of the invention includes a light source 21, an image-gaining processing module 22, a modulating module 23 and an imager 24. The image-gaining processing module 22 receives an image signal A, generates a gain value Q and generates an image-gaining signal A′ according to the gain value G and the image signal A. The modulating module 23 is electrically connected with the light source 21 and the image-gaining processing module 22, and generates a control signal C according to the gain value G to control the brightness B′ of the light source 11, wherein the brightness B′ comes out by multiplying the brightness B of the original light by the inverse of the gain value (1/G). The imager 24 is electrically connected with the image-gaining processing module 22, receives the image-gaining signal A′, and produces an image an image using the adjusted light from the light source.

In the present embodiment, the image-gaining processing module 22 includes an image gaining module 221 and an image processing module 222. The image gaining module 221 generates a gain value G using the input image signal A. The image processing module 222 is electrically connected with the image gaining module 221, and generates an image-gaining signal A′ according to the gain value G and the image signal A. The display device 2 further includes a gray level processing module 25.

The features and functions of the light source 21, the image gaining module 221, the image processing module 222, the modulating module 23, the imager 24, and the gray level processing module 25 are the same to those same elements described previously, so the detailed descriptions are omitted here for concise purpose.

The display device according to the invention obtains a gain value using the input signal, multiplies the input signal by the gain value, and adjusts the brightness of the light to become the multiple of the inverse of the gain value to enhance the dynamic range of the display device. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

The description should not be construed in a limiting sense. Any modifications and changes within the spirit and scope of the invention should be included in the appended claims.

1. A display device, comprising:
a light source;
an image-gaining processing module, which receives an image signal, generates a gain value, and generates an image-gaining signal according to the gain value and the image signal;
a modulating module electrically connected with the light source and the image-gaining processing module, wherein the modulating module generates a control signal according to the gain value to control the brightness of the light from the light source to become a multiple of the original brightness of the light from the light source and the inverse of the gain value; and
an imager electrically connected with the image-gaining processing module, wherein the imager receives the image-gaining signal, and produces an image using the controlled light from the light source.

2. The display device according to claim 1, wherein the image-gaining processing module includes an image gaining module and an image processing module, the image gaining module generates the gain value using the image signal, the image processing module is electrically connected with the image gaining module, and generates an image-gaining signal according to the gain value and the image signal.

3. The display device according to claim 1, wherein the light source is a digital-controlled light source.

4. The display device according to claim 1, wherein the light source is an analog-controlled light source.

5. The display device according to claim 1, wherein the light source is a light-emitting diode (LED), a light bulb, a laser or an organic LED.

6. The display device according to claim 1, wherein the modulating module is a digital modulating module.

7. The display device according to claim 1, wherein the modulating module is an analog modulating module.

8. The display device according to claim 1, wherein the image-gaining signal equals to the gain value multiplied by the image signal.

9. The display device according to claim 1, wherein the image-gaining processing module determines the maximum gray level of the image signal, and divides the maximum gray level of the imager by the maximum gray level of the image signal to obtain the gain value.

10. The display device according to claim 1, wherein the image-gaining processing module determines the maximum intensity of the image signal, and divides the maximum intensity of the imager by the maximum intensity of the image signal to obtain the gain value.

11. The display device according to claim 1, wherein the image-gaining processing module converts the image signal represented by gray level to the image signal represented by intensity.

12. The display device according to claim 1, wherein the image-gaining processing module converts the image signal represented by intensity to the image signal represented by gray level.

13. The display device according to claim 1, wherein the image-gaining processing module converts the image-gaining signal represented by gray level to the image-gaining signal represented by intensity.

14. The display device according to claim 1, wherein the image-gaining processing module converts the image-gaining signal represented by intensity to the image-gaining signal represented by gray level.

15. The display device according to claim 1, further comprising:
a gray level processing module, which converts the image signal represented by gray level to the image signal represented by intensity.

16. The display device according to claim 1, further comprising:
a gray level processing module, which converts the image signal represented by intensity to the image signal represented by gray level.

17. The display device according to claim 1, further comprising:
a gray level processing module, which converts the image-gaining signal represented by gray level to the image-gaining signal represented by intensity.

18. The display device according to claim 1, further comprising:
a gray level processing module, which converts the image-gaining signal represented by intensity to the image-gaining signal represented by gray level.

19. The display device according to claim 1, wherein the imager receives the image-gaining signal, and produces the image using the adjusted light source, the image substantially equals to the image signal.

20. The display device according to claim 1, wherein the imager comprises a display screen.

21. The display device according to claim 1, wherein the imager comprises an LCD light valve.

22. The display device according to claim 1, wherein the imager comprises an LCD reflection panel.

23. The display device according to claim 1, wherein the imager comprises a digital micro-mirror device.

24. The display device according to claim 1, wherein the imager is an LCD panel.

25. The display device according to claim 1, wherein the display device is of a projection type.

26. A display device, comprising:
a light source;
an image gaining module, which receives an image signal and generates a gain value;
a modulating module electrically connected with the light source and the image gaining module, wherein the modulating module generates a control signal according to the gain value to control the brightness of the light from the light source to become a multiple of the original brightness of the light from the light source and the inverse of the gain value;
an image processing module electrically connected with the image gaining module, wherein the image processing module generates an image-gaining signal according to the gain value and the image signal; and
an imager electrically connected with the image-gaining processing module, wherein the imager receives the image-gaining signal, and produces an image using the controlled light from the light source.
